(19) United States
(12) Patent Application Publication
(10) Pub. No.: US 2017/0269712 A1
(43) Pub. Date: Sep. 21, 2017

(54) IMMERSIVE VIRTUAL EXPERIENCE USING A MOBILE COMMUNICATION DEVICE

(71) Applicant: ADTILE TECHNOLOGIES INC., San Diego, CA (US)

(72) Inventors: Nils Forsblom, San Diego, CA (US); Maximilian Metti, San Diego, CA (US); Angelo Scandaliato, San Diego, CA (US); Fatemeh Bateni, San Diego, CA (US)

(21) Appl. No.: 15/461,235

(22) Filed: Mar. 16, 2017

Related U.S. Application Data
(60) Provisional application No. 62/308,874, filed on Mar. 16, 2016.

(51) Int. Cl. G06F 3/0346; G06F 3/01; G06F 3/00; G06T 19/00

(52) U.S. Cl. CPC G06F 3/0346; G06T 19/006; G06F 3/016; G06F 3/017; G06F 3/005

(57) ABSTRACT

An immersive virtual experience using a mobile communications device includes receiving a motion sensor input on a motion sensor input modality of the mobile communications device. The motion sensor input is translated to at least a set of quantified values. A user-initiated effect is generated within a three-dimensional virtual environment, which is in response to a substantial match between the set of quantified values translated from the received motion sensor input to a set of predefined values.

### CROSS-REFERENCE TO RELATED APPLICATIONS

This application relates to and claims the benefit of U.S. Provisional Application No. 62/308,874 filed Mar. 16, 2016 and entitled “360 DEGREES IMMERSIVE MOTION VIDEO EXPERIENCE AND INTERACTIONS,” the entire disclosure of which is hereby wholly incorporated by reference.

### STATEMENT RE: FEDERALLY SPONSORED RESEARCH/DEVELOPMENT

Not Applicable

### BACKGROUND

Technical Field

The present disclosure relates generally to human-computer interfaces and mobile devices, and more particularly, to motion-based interactions with a three-dimensional virtual environment.

2. Related Art

Mobile devices fulfill a variety of roles, from voice communications and text-based communications such as Short Message Service (SMS) and e-mail, to calendaring, task lists, and contact management, as well as typical Internet based functions such as web browsing, social networking, online shopping, and online banking. With the integration of additional hardware components, mobile devices can also be used for photography or taking snapshots, navigation with mapping and Global Positioning System (GPS), cashless payments with NFC (Near Field Communications) point-of-sale terminals, and so forth. Such devices have seen widespread adoption in part due to the convenient accessibility of these functions and more from a single portable device that can always be within the user's reach.

Although mobile devices can take on different form factors with varying dimensions, there are several commonalities between devices that share this designation. These include a general purpose data processor that executes pre-programmed instructions, along with wireless communication modules by which data is transmitted and received. The processor further cooperates with multiple input/output devices, including combination touch input display screens, audio components such as speakers, microphones, and related integrated circuits, GPS modules, and physical buttons/input modalities. More recent devices also include accelerometers and compasses that can sense motion and direction. For portability purposes, all of these components are powered by an on-board battery. In order to accommodate the low power consumption requirements, ARM architecture processors have been favored for mobile devices. Several distance and speed-dependent communication protocols may be implemented, including longer range cellular network modalities such as GSM (Global System for Mobile communications), CDMA, and so forth, high speed local area networking modalities such as WiFi, and close range device-to-device data communication modalities such as Bluetooth.

Management of these hardware components is performed by a mobile operating system, also referenced in the art as a mobile platform. The mobile operating system provides several fundamental software modules and a common input/output interface that can be used by third party applications via application programming interfaces.

User interaction with the mobile device, including the invoking of the functionality of these applications and the presentation of the results therefrom, is, for the most part, restricted to the graphical touch user interface. That is, the extent of any user interaction is limited to what can be displayed on the screen, and the inputs that can be provided to the touch interface are similarly limited to what can be detected by the touch input panel. Touch interfaces in which users tap, slide, flick, pinch regions of the sensor panel overlaying the displayed graphical elements with one or more fingers, particularly when coupled with corresponding animated display reactions responsive to such actions, may be more intuitive than conventional keyboard and mouse input modalities associated with personal computer systems. Thus, minimal training and instruction is required for the user to operate these devices.

However, mobile devices must have a small footprint for portability reasons. Depending on the manufacturer's specific configuration, the screen may be three to five inches diagonally. One of the inherent usability limitations associated with mobile devices is the reduced screen size; despite improvements in resolution allowing for smaller objects to be rendered clearly, buttons and other functional elements of the interface nevertheless occupy a large area of the screen. Accordingly, notwithstanding the enhanced interactivity possible with multi-touch input gestures, the small display area remains a significant restriction of the mobile device user interface. This limitation is particularly acute in graphic arts applications, where the canvas is effectively restricted to the size of the screen. Although the logical canvas can be extended as much as needed, zooming in and out while attempting to input graphics is cumbersome, even with the larger tablet form factors.

Expanding beyond the confines of the touch interface, some app developers have utilized the integrated accelerometer as an input modality. Some applications such as games are suited for motion-based controls, and typically utilize roll, pitch, and yaw rotations applied to the mobile device as inputs that control an on-screen element. In the area of advertising, motion controls have been used as well. See, for example, U.S. Patent Application Pub. No. 2015/0186944, the entire contents of which is incorporated herein by reference. More recent remote controllers for video game console systems also have incorporated accelerometers such that motion imparted to the controller is translated to a corresponding virtual action displayed on-screen.

Accelerometer data can also be utilized in other contexts, particularly those that are incorporated into wearable devices. However, in these applications, the data is typically analyzed over a wide time period and limited to making general assessments of the physical activity of a user.

Because motion is one of the most native forms of interaction between human beings and tangible objects, it would be desirable to utilize such inputs to the mobile device for interactions between a user and a three-dimensional virtual environment.

### BRIEF SUMMARY

The present disclosure contemplates various methods and devices for producing an immersive virtual experience. In accordance with one embodiment, there is a method for producing an immersive virtual experience using a mobile communications device. The method includes receiving a motion sensor input on a motion sensor input modality of the mobile communications device, translating the motion sensor input to at least a set of quantified values, and generating, within a three-dimensional virtual environment, a user-initiated effect in response to a substantial match between the set of quantified values translated from the received motion sensor input to a set of predefined values.

The method may include displaying the user-initiated effect on the mobile communications device, which may include displaying a movable-window view of the three-dimensional virtual environment on the mobile communications device. The method may include outputting, on the mobile communications device, at least one of visual, auditory, and haptic feedback in response to a substantial match between the set of quantified values translated from the received motion sensor input to a set of predefined values. The method may include displaying, on the mobile communications device, user-initiated effect invocation instructions corresponding to the set of predefined values. The method may include receiving an external input on an external input modality of the mobile communications device and generating, within the three-dimensional virtual environment, an externally initiated effect in response to the received external input. The method may include displaying such externally initiated effect on the mobile communications device, which may include displaying a movable-window view of the three-dimensional virtual environment on the mobile communications device. The external input modality may include an indoor positioning system receiver, with the external input being a receipt of a beacon signal transmitted from an indoor positioning system transmitter. The external input modality may include a wireless communications network receiver, with the external input being a receipt of a wireless communications signal transmitted from a wireless communications network transmitter.

The motion sensor input modality may include at least one of an accelerometer, a compass, and a gyroscope, which may be integrated into the mobile communications device, with the motion sensor input being a sequence of motions applied to the mobile communications device by a user that are translated to the set of quantified values by the at least one of an accelerometer, a compass, and a gyroscope. Alternatively, or additionally, the at least one of an accelerometer, a compass, and a gyroscope may be in an external device wearable by a user and in communication with the mobile communications device, with the motion sensor input being a sequence of motions applied to the external device by the user that are translated to the set of quantified values by the at least one of an accelerometer, a compass, and a gyroscope. The motion sensor input may be, for example, movement of the mobile communications device or steps walked or run by a user as measured by an accelerometer, a physical gesture as measured by a gyroscope, a direction as measured by a compass, or steps walked or run by a user in a defined direction as measured by a combination of an accelerometer and a compass.

The method may include receiving a visual, auditory, or touch input on a secondary input modality of the mobile communications device and translating the visual, auditory, or touch input to at least a set of secondary quantified values, and generating the generating of the user-initiated effect may be further in response to a substantial match between the set of secondary quantified values translated from the visual, auditory, or touch input to the set of predefined values. The secondary input modality may include a camera, with the visual, auditory, or touch input including a sequence of user gestures graphically captured by the camera.

In accordance with another embodiment, there is an article of manufacture including a non-transitory program storage medium readable by a mobile communications device, the medium tangibly embodying one or more programs of instructions executable by the device to perform a method for producing an immersive virtual experience. The method includes receiving a motion sensor input on a motion sensor input modality of the mobile communications device, translating the motion sensor input to at least a set of quantified values, and generating, within a three-dimensional virtual environment, a user-initiated effect in response to a substantial match between the set of quantified values translated from the received motion sensor input to a set of predefined values. The article of manufacture may include the mobile communications device, which may include a processor or programmable circuitry for executing the one or more programs of instructions.

In accordance with another embodiment, there is a mobile communications device operable to produce an immersive virtual experience. The mobile communications device includes a motion sensor for receiving a motion sensor input and translating the motion sensor input to at least a set of quantified values and a processor for generating, within a three-dimensional virtual environment, a user-initiated effect in response to a substantial match between the set of quantified values translated by the motion sensor from the received motion sensor input to a set of predefined values.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates one exemplary mobile communications device 10 on which various embodiments of the present disclosure may be implemented;

FIG. 2 illustrates one embodiment of a method for producing an immersive virtual experience using the mobile communications device 10;

FIGS. 3A-3D relate to a specific example of an immersive virtual experience produced according to the method of FIG. 2, of which FIG. 3A shows the display of user-initiated effect invocation instructions, FIG. 3B shows the receipt of motion sensor input, FIG. 3C shows the display of a user-initiated effect, and FIG. 3D shows a panned view of the display of the user-initiated effect;

FIG. 4 shows another example of an immersive virtual experience produced according to the method of FIG. 2;

FIG. 5 shows another example of an immersive virtual experience produced according to the method of FIG. 2;

FIGS. 6A-6C relate to another specific example of an immersive virtual experience produced according to the method of FIG. 2, of which FIG. 6A shows the display of user-initiated effect invocation instructions, FIG. 6B shows the receipt of motion sensor input, and FIG. 6C shows the display of a user-initiated effect;

FIG. 7 shows another example of an immersive virtual experience produced according to the method of FIG. 2;

FIG. 8 shows another example of an immersive virtual experience produced according to the method of FIG. 2;

FIG. 9 shows another example of an immersive virtual experience produced according to the method of FIG. 2;

FIG. 10 illustrates one embodiment of a sub-method of the method of FIG. 2;

FIG. 11 shows an example of an immersive virtual experience produced according to the method of FIG. 2 and the sub-method of FIG. 10;

FIG. 12 shows another example of an immersive virtual experience produced according to the method of FIG. 2 and the sub-method of FIG. 10;

FIG. 13 shows another example of an immersive virtual experience produced according to the method of FIG. 2 and the sub-method of FIG. 10;

FIG. 14 shows another example of an immersive virtual experience produced according to the method of FIG. 2 and the sub-method of FIG. 10; and

FIG. 15 shows another example of an immersive virtual experience produced according to the method of FIG. 2 and the sub-method of FIG. 10.

### DETAILED DESCRIPTION

The present disclosure encompasses various embodiments of methods and devices for producing an immersive virtual experience. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

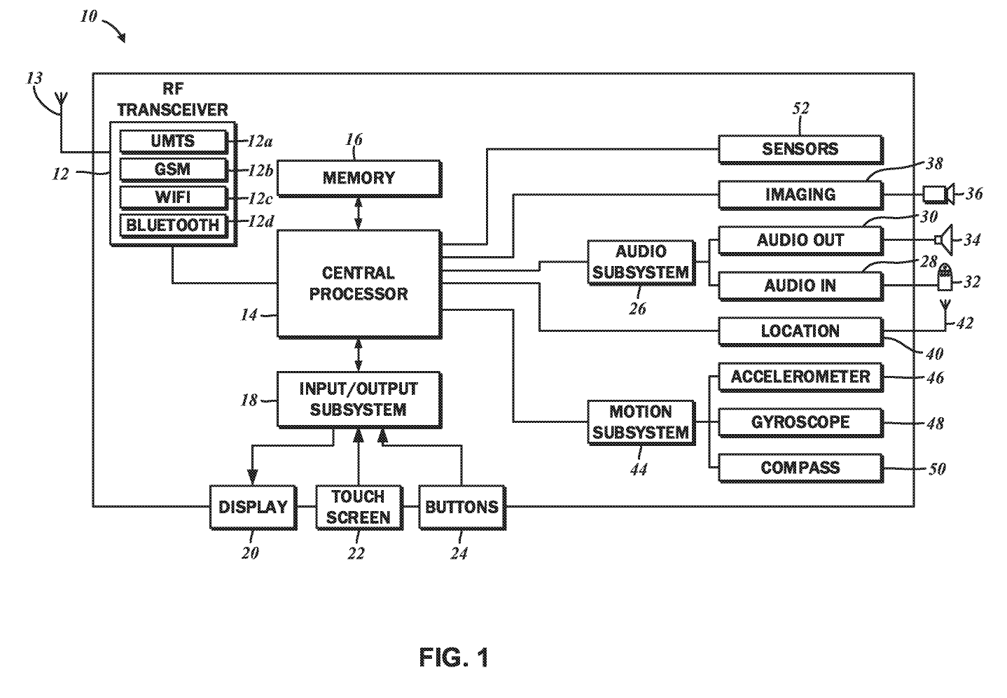

FIG. 1 illustrates one exemplary mobile communications device 10 on which various embodiments of the present disclosure may be implemented. The mobile communications device 10 may be a smartphone, and therefore include a radio frequency (RF) transceiver 12 that transmits and receives signals via an antenna 13. Conventional devices are capable of handling multiple wireless communications modes simultaneously. These include several digital phone modalities such as UMTS (Universal Mobile Telecommunications System), 4 G LTE (Long Term Evolution), and the like. For example, the RF transceiver 12 includes a UMTS module 12a. To the extent that coverage of such more advanced services may be limited, it may be possible to drop down to a different but related modality such as EDGE (Enhanced Data rates for GSM Evolution) or GSM (Global System for Mobile communications), with specific modules therefor also being incorporated in the RF transceiver 12, for example, GSM module 12b. Aside from multiple digital phone technologies, the RF transceiver 12 may implement other wireless communications modalities such as WiFi for local area networking and accessing the Internet by way of local area networks, and Bluetooth for linking peripheral devices such as headsets. Accordingly, the RF transceiver may include a WiFi module 12c and a Bluetooth module 12d. The enumeration of various wireless networking modules is not intended to be limiting, and others may be included without departing from the scope of the present disclosure.

The mobile communications device 10 is understood to implement a wide range of functionality through different software applications, which are colloquially known as “apps” in the mobile device context. The software applications are comprised of pre-programmed instructions that are executed by a central processor 14 and that may be stored on a memory 16. The results of these executed instructions may be output for viewing by a user, and the sequence/parameters of those instructions may be modified via inputs from the user. To this end, the central processor 14 interfaces with an input/output subsystem 18 that manages the output functionality of a display 20 and the input functionality of a touch screen 22 and one or more buttons 24.

In a conventional smartphone device, the user primarily interacts with a graphical user interface that is generated on the display 20 and includes various user interface elements that can be activated based on haptic inputs received on the touch screen 22 at positions corresponding to the underlying displayed interface element. One of the buttons 24 may serve a general purpose escape function, while another may serve to power up or power down the mobile communications device 10. Additionally, there may be other buttons and switches for controlling volume, limiting haptic entry, and so forth. Those having ordinary skill in the art will recognize other possible input/output devices that could be integrated into the mobile communications device 10, and the purposes such devices would serve. Other smartphone devices may include keyboards (not shown) and other mechanical input devices, and the presently disclosed interaction methods detailed more fully below are understood to be applicable to such alternative input modalities.

The mobile communications device 10 includes several other peripheral devices. One of the more basic is an audio subsystem 26 with an audio input 28 and an audio output 30 that allows the user to conduct voice telephone calls. The audio input 28 is connected to a microphone 32 that converts sound to electrical signals, and may include amplifier and ADC (analog to digital converter) circuitry that transforms the continuous analog electrical signals to digital data. Furthermore, the audio output 30 is connected to a loudspeaker 34 that converts electrical signals to air pressure waves that result in sound, and may likewise include amplifier and DAC (digital to analog converter) circuitry that transforms the digital sound data to a continuous analog electrical signal that drives the loudspeaker 34. Furthermore, it is possible to capture still images and video via a camera 36 that is managed by an imaging module 38.

Due to its inherent mobility, users can access information and interact with the mobile communications device 10 practically anywhere. Additional context in this regard is discernible from inputs pertaining to location, movement, and physical and geographical orientation, which further enhance the user experience. Accordingly, the mobile communications device 10 includes a location module 40, which may be a Global Positioning System (GPS) receiver that is connected to a separate antenna 42 and generates coordinates data of the current location as extrapolated from signals received from the network of GPS satellites. Motions imparted upon the mobile communications device 10, as well as the physical and geographical orientation of the same, may be captured as data with a motion subsystem 44, in particular, with an accelerometer 46, a gyroscope 48, and a compass 50, respectively. Although in some embodiments the accelerometer 46, the gyroscope 48, and the compass 50 directly communicate with the central processor 14, more recent variations of the mobile communications device 10 utilize the motion subsystem 44 that is embodied as a separate co-processor to which the acceleration and orientation processing is offloaded for greater efficiency and reduced electrical power consumption. In either case, the outputs of the accelerometer 46, the gyroscope 48, and the compass 50 may be combined in various ways to produce “soft” sensor output, such as a pedometer reading. One exemplary embodiment of the mobile communications device 10 is the Apple iPhone with the M7 motion co-processor.

The components of the motion subsystem 44, including the accelerometer 46, the gyroscope 48, and the compass 50, may be integrated into the mobile communications device 10 or may be incorporated into a separate, external device. This external device may be wearable by the user and communicatively linked to the mobile communications device 10 over the aforementioned data link modalities. The same physical interactions contemplated with the mobile communications device 10 to invoke various functions as discussed in further detail below may be possible with such external wearable device.

There are other sensors 52 that can be utilized in the mobile communications device 10 for different purposes. For example, one of the other sensors 52 may be a proximity sensor to detect the presence or absence of the user to invoke certain functions, while another may be a light sensor that adjusts the brightness of the display 20 according to ambient light conditions. Those having ordinary skill in the art will recognize that other sensors 52 beyond those considered herein are also possible.

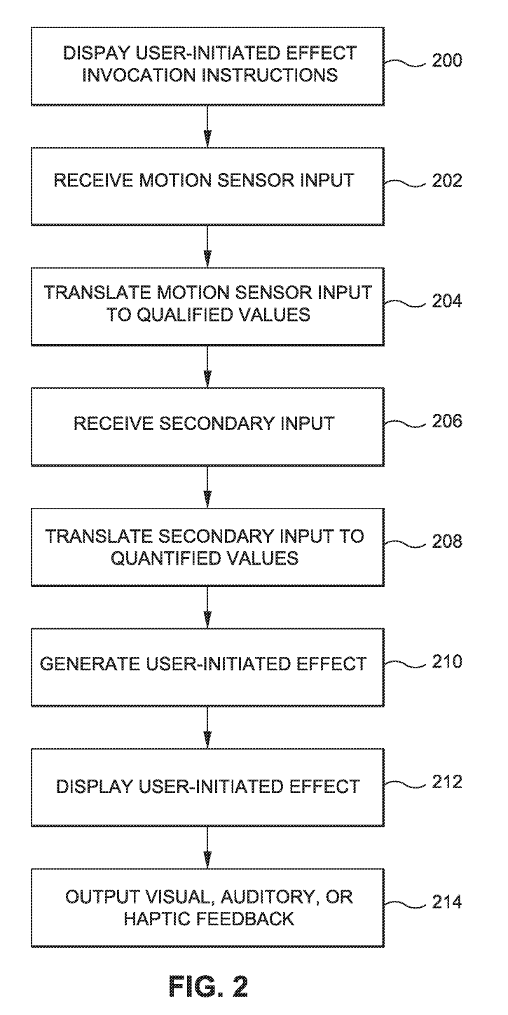

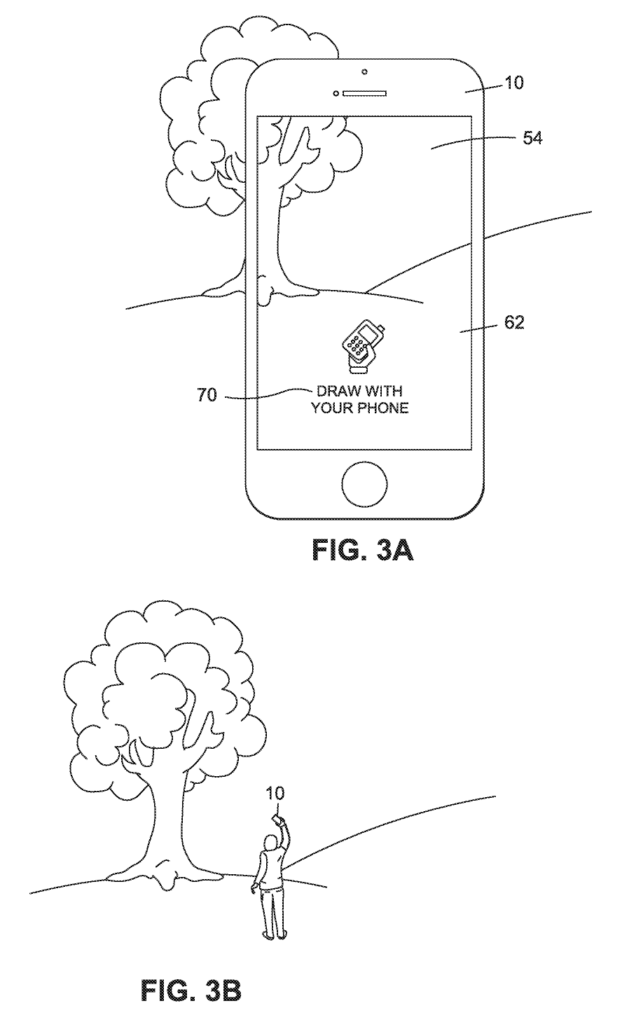

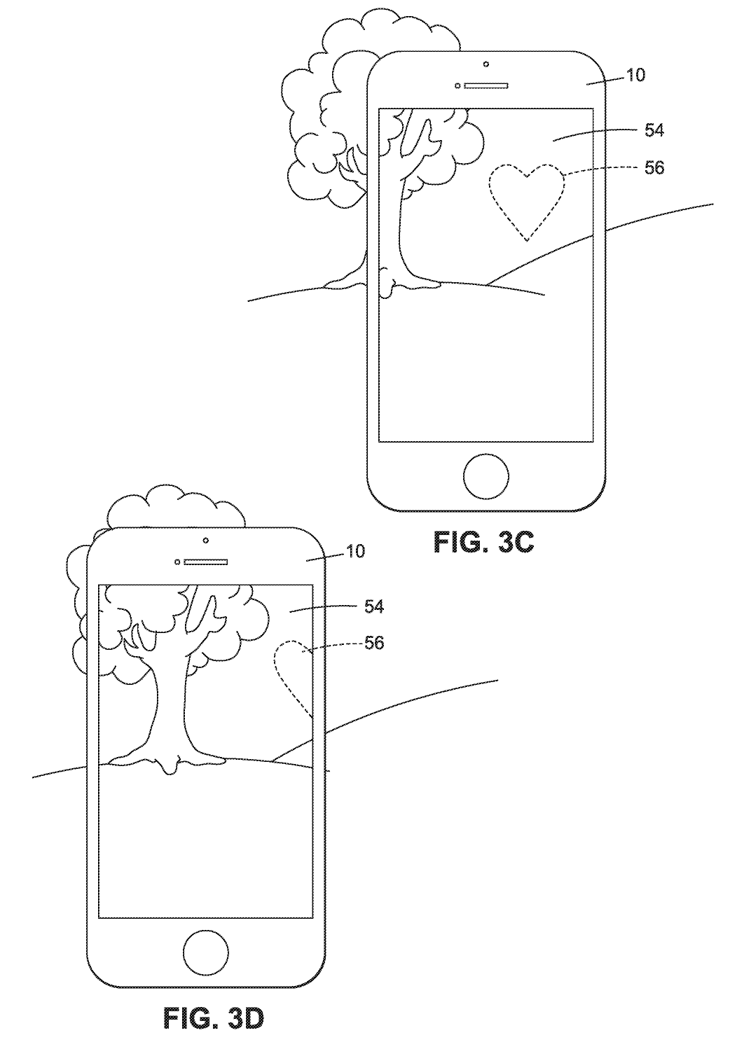

With reference to the flowchart of FIG. 2, one embodiment of a method for producing an immersive virtual experience using the mobile communications device 10 will be described. None of the steps of the method disclosed herein should be deemed to require sequential execution. The method begins with an optional step 200 of displaying, on the mobile communications device, user-initiated effect invocation instructions 70. FIG. 3A illustrates one exemplary graphical interface 62 rendered on the display 54 of the mobile communications device 10. The user is prompted as to what motion, gesture, or other action to perform in order to generate a user-initiated effect within a three-dimensional virtual environment. The user-initiated effect invocation instructions 70 may, for example, be displayed as text and/or graphics within the graphical interface 62 at startup of an application for producing an immersive virtual experience or at any other time, e.g. during loading or at a time that the application is ready to receive motion sensor input as described below. With regard to such an application, it should be noted that various preliminary steps may occur prior to step 200 including, for example, displaying a content initialization screen, detecting software compatibility and/or hardware capability, and/or receiving an initial user input or external input to trigger the activation of an immersive virtual experience. Activation of an immersive virtual experience may include, for example, initiating the collection and evaluation of motion sensor input and other input data using a control switch.

Continuing on, the method includes a step 202 of receiving a motion sensor input on a motion sensor input modality of the mobile communications device 10. The motion sensor input modality may include at least one of the accelerometer 46, the compass 50, and the gyroscope 48 and may further include the motion subsystem 44. The received motion sensor input is thereafter translated to at least a set of quantified values in accordance with a step 204. In a case where the motion sensor input modality includes at least one of the accelerometer 46, the compass 50, and the gyroscope 48 integrated in the mobile communications device 10, the motion sensor input may be a sequence of motions applied to the mobile communications device 10 by a user that are translated to the set of quantified values by the at least one of the accelerometer 46, the compass 50, and the gyroscope 48. In a case where the motion sensor input modality includes at least one of the accelerometer 46, the compass 50, and the gyroscope 48 in an external device wearable by a user and in communication with the mobile communications device 10, the motion sensor input may be a sequence of motions applied to the external device by a user that are translated to the set of quantified values by the at least one of the accelerometer 46, the compass 50, and the gyroscope 48.The motion sensor input could be one set of data captured in one time instant as would be the case for direction and orientation, or it could be multiple sets of data captured over multiple time instances that represent a movement action. The motion sensor input may be, for example, movement of the mobile communications device 10 or steps walked or run by a user as measured by the accelerometer 46, a physical gesture as measured by the gyroscope 48, a direction as measured by the compass 50, steps walked or run by a user in a defined direction as measured by a combination of the accelerometer 46 and the compass 50, a detection of a “shake” motion of the mobile communications device 10 as measured by the accelerometer 46 and/or the gyroscope 48, etc.

The method may further include a step 206 of receiving a secondary input, e.g. a visual, auditory, or touch input, on a secondary input modality of the mobile communications device 10. The secondary input modality may include at least one of the touch screen 22, the one or more buttons 24, the microphone 32, the camera 36, the location module 40, and the other sensors 52. For example, in a case where the secondary input modality includes the microphone 32, the secondary input may include audio input such as a user shouting or singing. In a case where the secondary input modality includes the camera 36, the secondary input may include a sequence of user gestures graphically captured by the camera 36. The received secondary input, e.g. visual, auditory, or touch input, is thereafter translated to at least a set of secondary quantified values in accordance with a step 208. The secondary input could be one set of data captured in one time instant or it could be multiple sets of data captured over multiple time instances that represent a movement action.

The method for producing an immersive virtual experience continues with a step 210 of generating, within a three-dimensional virtual environment, a user-initiated effect in response to a substantial match between the set of quantified values translated from the received motion sensor input to a set of predefined values. The set of predefined values may include data correlated with a specific movement of the mobile communications device or the user. For example, in a case where the motion sensor input will include data of the accelerometer 46, the predefined values may define an accelerometer data threshold above which (or thresholds between which) it can be determined that a user of the mobile communications device is walking. Thus, a substantial match between the quantified values translated from the received motion sensor input to the set of predefined values might indicate that the user of the mobile communications device is walking. Various algorithms to determine such matches are known in the art, and any one can be substituted without departing from the scope of the present disclosure.

In a case where secondary input has also been received and translated to a set of secondary quantified values, generating the user-initiated effect in step 210 may be further in response to a substantial match between the set of secondary quantified values translated from the secondary input, e.g. the visual, auditory, or touch input, to the set of predefined values. In this way, a combination of motion sensor input and other input may be used to generate the user-initiated effect.

As mentioned above, the method for producing an immersive virtual experience may include a step of displaying user-initiated effect invocation instructions 70. Such user-initiated effect invocation instructions 70 may correspond to the set of predefined values. In this way, a user may be instructed appropriately to generate the user-initiated effect by executing one or more specific movements and/or other device interactions.

Most generally, the user-initiated effect may be any effect, e.g. the addition, removal, or change of any feature, within a three-dimensional virtual environment. Such effect may be visually perceptible, e.g. the creation of a new visual feature such as a drawn line or a virtual physical object. That is, the effect may be seen in a visual display of the three-dimensional virtual environment. Alternatively, or additionally, the user-initiated effect may be an auditory effect emanating from a specific locality in virtual space and perceivable on a loudspeaker (such as the loudspeaker 34 of the mobile communications device 10), a haptic effect emanating from a specific locality in virtual space and perceivable on a haptic output device (such as the touch screen 22 or a vibration module of the mobile communications device 10), a localized command or instruction that provides a link to a web site or other remote resource to a mobile communications device 10 entering its proximity in virtual space, or any other entity that can be defined in a three-dimensional virtual environment and perceivable by an application that can access the three-dimensional virtual environment.

As explained above, the user-initiated effect may be visually perceptible. The method may further include a step 212 of displaying the user-initiated effect on the mobile communications device 10 or an external device local or remote to the mobile communications device 10. In a basic form, displaying the user-initiated effect may include displaying text or graphics representative of the effect and/or its location in virtual space. For example, such text or graphics may be displayed at an arbitrary position on the display 20. Further, the user-initiated effect may be displayed in such a way as to be viewable in its visual context within the three-dimensional virtual environment. Thus, displaying the user-initiated effect in step 212 may include displaying a movable-window view of the three-dimensional virtual environment on the mobile communications device 10. That is, a portion of the three-dimensional virtual environment may be displayed on the display 20 of the mobile communications device 10 and the user of the mobile communications device 10 may adjust which portion of the three-dimensional virtual environment is displayed by panning the mobile communications device 10 through space. Thus, the angular attitude of the mobile communications device 10, as measured, e.g. by the gyroscope 48, may be used to determine which portion of the three-dimensional virtual environment is being viewed, with the user-initiated effect being visible within the three-dimensional virtual environment when the relevant portion of the three-dimensional virtual environment is displayed. A movable-window view may also be displayed on an external device worn on or near the user's eyes and communicatively linked with the mobile communications device 10 (e.g. viewing glasses or visor). As another example, displaying the user-initiated effect in step 212 may include displaying a large-area view of the three-dimensional virtual environment on an external device such as a stationary display local to the user. A large-area view may be, for example, a bird's eye view or an angled view from a distance (e.g. a corner of a room), which may provide a useful perspective on the three-dimensional virtual environment in some contexts, such as when a user is creating a three-dimensional line drawing or sculpture in virtual space and would like to simultaneously view the project from a distance.

It should be noted that embodiments are also contemplated in which there is no visual display of the three-dimensional virtual environment whatsoever. For example, a user may interact with the three-dimensional virtual environment “blindly” by traversing virtual space in search of a hidden virtual object, where proximity to the hidden virtual object is signaled to the user by auditory or haptic output in a kind of “hotter/colder” game. In such an embodiment, the three-dimensional virtual environment may be constructed using data of the user's real-world environment (e.g. a house) so that a virtual hidden object can be hidden somewhere that is accessible in the real world. The arrival of the user at the hidden virtual object, determined based on the motion sensor input, may trigger the generation of a user-initiated effect such as the relocation of the hidden virtual object.

The method may further include a step 214 of outputting, on the mobile communications device 10, at least one of visual, auditory, and haptic feedback in response to a substantial match between the set of quantified values translated from the received motion sensor input to a set of predefined values. Such feedback may enhance a user's feeling of interaction with the three-dimensional virtual environment. For example, when creating a 3-dimensional line drawing or sculpture in virtual space, the user's drawing or sculpting hand (e.g. the hand holding the mobile communications device 10) may cross a portion of virtual space that includes part of the already created drawing or sculpture. Haptic feedback such as a vibration may serve as an intuitive notification to the user that he is “touching” the drawing or sculpture, allowing the user to “feel” the contours of the project. Such haptic feedback can be made in response to a substantial match between the set of quantified values translated from the received motion sensor input, which may correlate to the position of the user 's drawing or sculpting hand, to a set of predefined values representing the virtual location of the already-created project. Similarly, any virtual boundary or object in the three-dimensional virtual environment can be associated with predefined values used to produce visual, auditory, and/or haptic feedback in response to a user “touching” the virtual boundary or object. Thus, in some examples, the predefined values used for determining a substantial match for purposes of outputting visual, auditory, or haptic feedback may be different from those predefined values used for determining a substantial match for purposes of generating a user-initiated effect. In other examples, successfully executing some action in the three-dimensional virtual environment, such as drawing (as opposed to moving the mobile communications device 10 or other drawing tool without drawing), may trigger visual, auditory, and/or haptic feedback on the mobile communications device 10. In this case, the predefined values for outputting feedback and the predefined values for generating a user-initiated effect may be one and the same, and, in such cases, it may be regarded that the substantial match results both in the generation of a user-initiated effect and the outputting of feedback.

Lastly, it should be noted that various additional steps may occur during or after the method of FIG. 2. For example, based on the user 's interaction, including any user-initiated effect, the mobile communication device 10 or an external device may compute analytics and/or store relevant data from the user 's experience for later use such as sharing. Such computation and storing, as well as any computation and storing needed for performing the various steps of the method of FIG. 2, may be performed, e.g. by the central processor 14 and memory 16.

FIGS. 3A-3D relate to a specific example of an immersive virtual experience produced according to the method of FIG. 2. As shown in FIG. 3A, a graphical user interface 54 of an application running on the mobile communications device 10 includes primarily a live view image similar to that of a camera's live preview mode or digital viewfinder, i.e. the default still or video capture mode for most smart phones, in which a captured image is continuously displayed on the display 20 such that the real world may be viewed effectively by looking “through” the mobile communications device 10. In the example of FIG. 3A, a portion of a real-world tree and a portion of the real-world horizon/hills can be seen in the through image, with the remainder of the tree and horizon/hills visible in the real-world setting outside the mobile communications device 10. In accordance with step 200 of the method of FIG. 2, the graphical user interface 54 further includes user-initiated effect invocation instructions 70 in the form of the text “DRAW WITH YOUR PHONE” and a graphic of a hand holding a smart phone. In the example of FIG. 3A, the user-initiated effect invocation instructions 70 are shown overlaying the through image on the graphical user interface 54 such that the through image may be seen “behind” the user-initiated effect invocation instructions 70, but alternative modes of display are contemplated as well, such as a pop-up window or a dedicated top, bottom, or side panel area of the graphical user interface 54. In the case of an application for producing an immersive virtual experience, such user-initiated effect invocation instructions 70 may be displayed or not depending on design or user preference, e.g. every time the application runs, the first time the application runs, or never, relying on user knowledge of the application or external instructions. Non-display modes of instruction, e.g. audio instructions, are also contemplated.

FIG. 3B shows the same real-world setting including the tree and horizon/hills, but this time the user of the mobile communications device 10 has moved into the area previously viewed in the through image and is following the user-initiated effect invocation instructions 70 by moving his phone around in the air in a drawing motion. In accordance with step 202 of the method of FIG. 2, the mobile communications device 10 thus receives motion sensor input on a motion sensor input modality including, e.g., the accelerometer 46, the compass 50, and/or the gyroscope 48, which is translated to at least a set of quantified values per step 204. In some embodiments, the user may initiate drawing by using a pen-down/pen-up toggle switch, e.g. by interaction with the touch screen 22, buttons 24, microphone 32 or any other input of the mobile communications device 10. In this way, the mobile communications device 10 may further receive secondary input in accordance with step 206, which may be translated into secondary quantified values per step 208 to be matched to predefined values.

In FIG. 3C, the user has returned to the same viewing position as in FIG. 3A to once again view the area through the mobile communications device 10. As can be seen, the user's drawing 56, a heart, is visible in the graphical user interface 54. In this way, the mobile communications device 10 may generate and display a user-initiated effect (the drawing 56) in accordance with steps 210 and 212. FIG. 3D illustrates the movable-window view of the three-dimensional virtual environment on the mobile communications device 10. As the user pans the mobile communication device 10 to the left as shown, different portions of the real-world tree and horizon/hills become visible in the graphical user interface 54 as expected of a through image, whereas the drawing 56 becomes “cut off” as it only exists in the three-dimensional virtual environment and not in the real world and thus cannot be viewed outside the movable-window view of the mobile communications device 10. Similarly, as the user approaches the drawing 56, the accelerometer 46 may measure the forward motion of the mobile communication device 10 and the drawing 56 may undergo appropriate magnification on the graphical user interface 54. In the case of a three-dimensional drawing, the drawing 56 may be viewed from different perspectives as the user walks around the drawing 56.

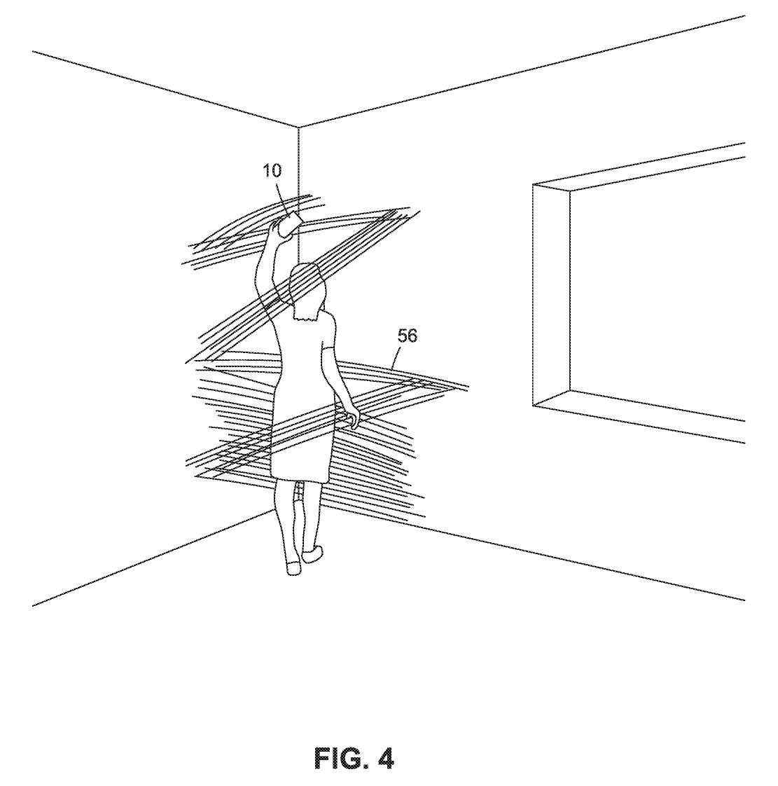

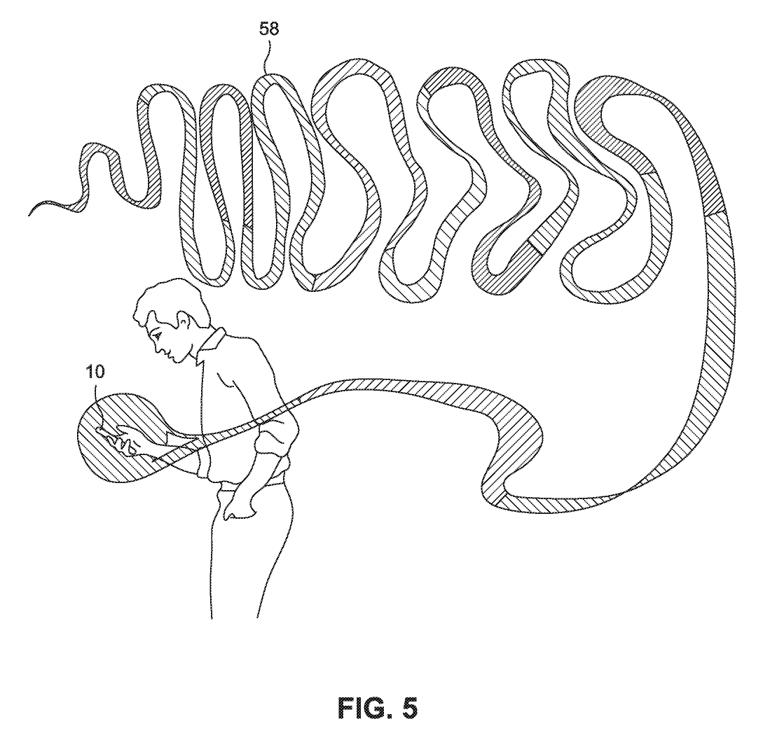

FIGS. 4 and 5 show further examples of the drawing/sculpting embodiment of FIGS. 3A-3D. In FIG. 4, a user of a mobile communications device 10 is shown in a room in the real-world creating a three-dimensional virtual drawing/sculpture 56 around herself. Such drawing/sculpture 56 may be created and displayed using the method of FIG. 2, with the display being, e.g., a movable-window view on the mobile communications device 10 or a large-area view on an external device showing the entire real-world room along with the virtual drawing/sculpture 56. In the example of FIG. 5, a user 's mobile communications device 10 is leaving a colorful light trail 58 in virtual space showing the path of the mobile communications device 10. The light trail 58 is another example of a user-initiated effect and may be used for creative aesthetic or entertainment purposes as well as for practical purposes, e.g. assisting someone who is following the user. For example, in accordance with the method of FIG. 2, a first user may produce a light trail 58 as a user-initiated effect in a three-dimensional virtual environment and a second user may view the three-dimensional virtual environment including the light trail 58 on a second mobile communications device 10 using, e.g. a movable-window view. In this way, the second user may more easily follow the first user or retrace his steps.

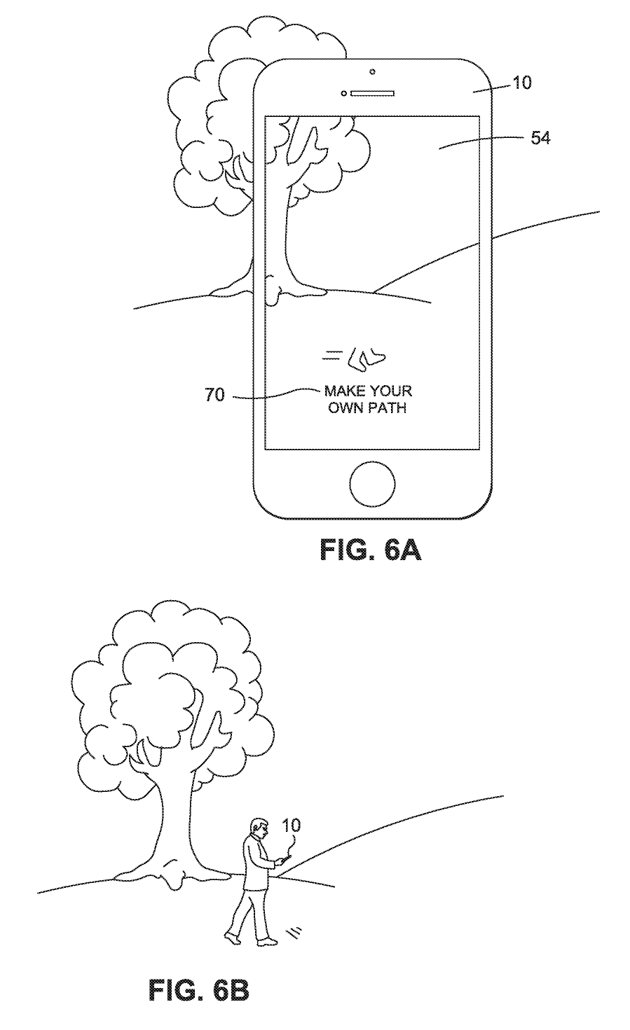

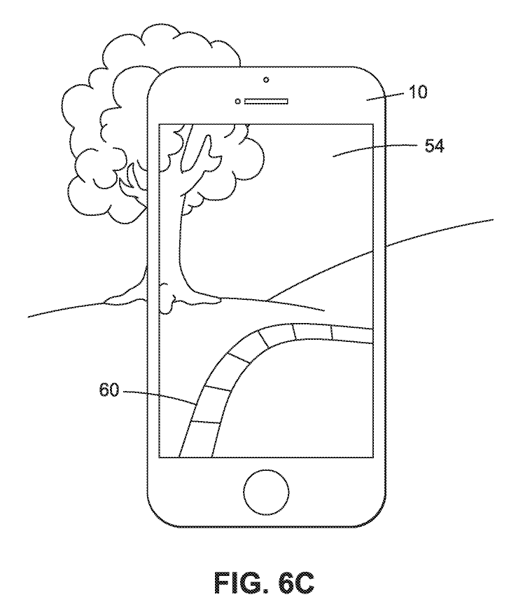

FIGS. 6A-6D relate to another specific example of an immersive virtual experience produced according to the method of FIG. 2. As shown in FIG. 6A, a graphical user interface 54 of an application running on the mobile communications device 10 includes primarily a through image similar to that of FIG. 3A. In the example of FIG. 6A, as in the example of FIG. 3A, a portion of a real-world tree and a portion of the real-world horizon/hills can be seen in the through image, with the remainder of the tree and horizon/hills visible in the real-world setting outside the mobile communications device 10. In accordance with step 200 of the method of FIG. 2, the graphical user interface 54 further includes user-initiated effect invocation instructions 70 in the form of the text “MAKE YOUR OWN PATH” and a graphic of legs walking overlaying the through image on the graphical user interface 54.

FIG. 6B shows the same real-world setting including the tree and horizon/hills, but this time the user of the mobile communications device 10 has moved into the area previously viewed in the through image and is following the user-initiated effect invocation instructions 70 by walking along to make his own path. In accordance with step 202 of the method of FIG. 2, the mobile communications device 10 thus receives motion sensor input on a motion sensor input modality including, e.g., the accelerometer 46, the compass 50, and/or the gyroscope 48, which may be used in combination as a pedometer or other “soft” sensor, and the motion sensor input is translated to at least a set of quantified values per step 204. In some embodiments, the user may toggle creation of the path by interaction with the touch screen 22, buttons 24, microphone 32 or any other input of the mobile communications device 10. In this way, the mobile communications device 10 may further receive secondary input in accordance with step 206, which may be translated into secondary quantified values per step 208 to be matched to predefined values.

In FIG. 6C, the user has returned to the same viewing position as in FIG. 6A to once again view the area through the mobile communications device 10. As can be seen, the user 's path 60 is visible in the graphical user interface 54, in this example in the form of a segmented stone path. In this way, the mobile communications device 10 may generate and display a user-initiated effect (the path 60) in accordance with steps 210 and 212.

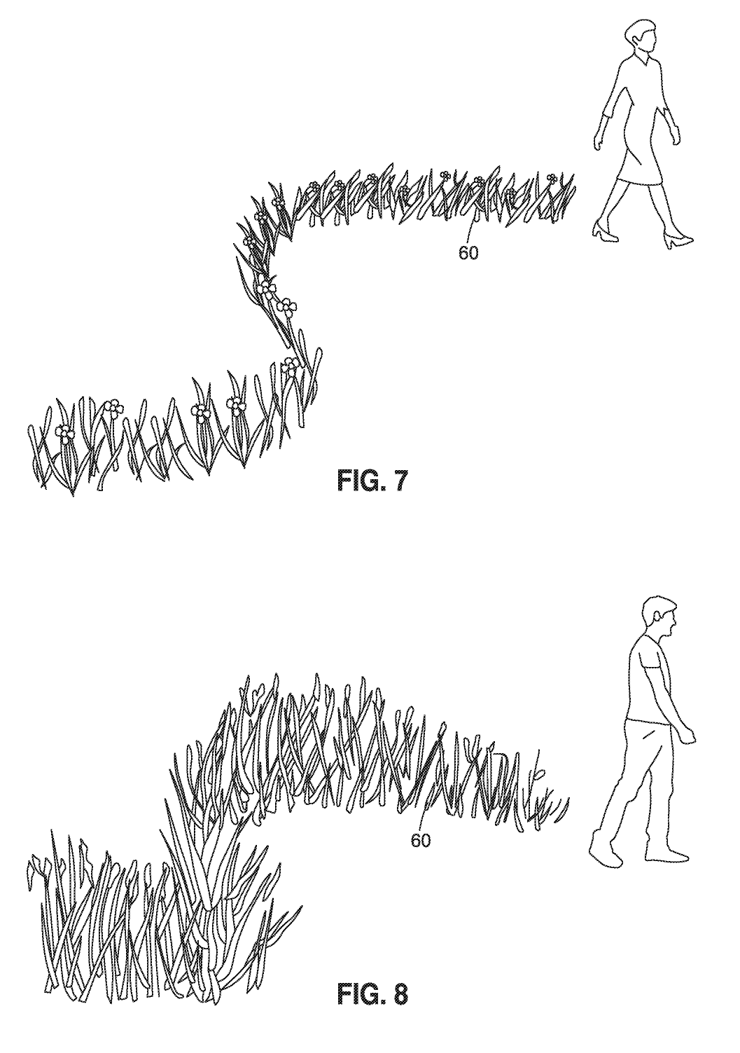

FIGS. 7-9 show further examples of the “make you own path” embodiment of FIGS. 6A-6C. In FIGS. 7 and 8, a user of a mobile communications device 10 is shown creating “green paths” of flowers (FIG. 7) and wheat (FIG. 8), respectively, instead of the segmented stone path in the example of FIGS. 6A-6C. In this way, the practical uses of producing such a user-initiated effect can be combined with aesthetic or meaningful expression of the user in the three-dimensional virtual environment.

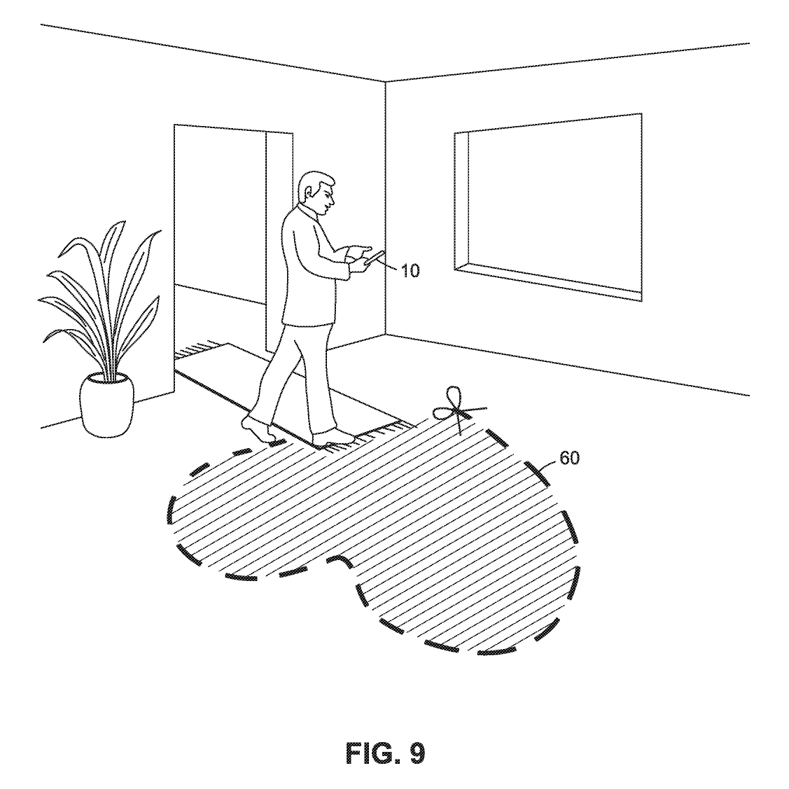

FIG. 9 shows a more complex example of the “make your own path” embodiment of FIGS. 6A-6C, in which the user is able to interact with the user-created path 60 in accordance with the method of FIG. 2. Before or after the generation of the path 60, the user may be given additional or follow-up user-initiated effect invocation instructions 70 in the form of, for example, the text “CUT YOUR PATH” and a graphic of scissors or “finger scissors” in accordance with step 200. In the example of FIG. 9, the user has already created a path 60 in the form of a dashed outline of a heart. The path 60 may have been made in substantially the same way as the path 60 of FIGS. 6A-6C. Note that the path 60 shown in FIG. 9 and its shaded interior is a user-initiated effect in a three-dimensional virtual environment viewable by the user on his mobile communications device 10, e.g. using a movable-window view. That is, it is in virtual space and would not generally be viewable from the perspective of FIG. 9 unless FIG. 9 itself is an external large-area view or second movable-window view of the same three-dimensional virtual environment. For ease of understanding, the path 60 is included in FIG. 9 to show what the user may effectively see when looking through his mobile communications device 10. (Similarly, in FIGS. 4, 5, 7, and 8, what the user may effectively see when looking through his/her mobile communications device 10 is shown for ease of understanding of the user's experience, even though the perspective of each drawing would generally prohibit it unless the drawing itself were an external large-area view or second movable-window view of the same three-dimensional virtual environment.) As part of this “CUT YOUR PATH” example, the interior of the path 60 may become shaded as an additional user-initiated effect when the user's drawing results in the completion of a closed shape.

While following along the already created path 60 using the movable-window view of his mobile communications device 10, the user gestures near the mobile communications device 10 in the shape of “finger scissors” along the path 60 as viewed through the movable-window. In accordance with step 202 of the method of FIG. 2, the mobile communications device 10 thus receives motion sensor input on a motion sensor input modality including, e.g., the accelerometer 46, the compass 50, and/or the gyroscope 48, which may be used in combination as a pedometer or other “soft” sensor, which is translated to at least a set of quantified values per step 204, and the mobile communications device 10 further receives, in accordance with step 206, secondary input including a sequence of user gestures graphically captured by the camera 36 of the mobile communications device 10, which is translated to at least a set of secondary quantified values per step 208 to be matched to predefined values. As the user “cuts” along the path 60, the mobile communications device 10 may generate and display a user-initiated effect in accordance with steps 210 and 212, for example, a colored line in place of the dashed line or the removal of the dashed line. In addition, in accordance with step 214, the user may be provided with feedback to inform the user that he is cutting on the line or off the line. For example, if the user holds the mobile communications device 10 in one hand and cuts with the other, the hand holding the mobile communications device 10 may feel vibration or other haptic feedback when the line is properly cut (or improperly cut). Instead, or in addition, audio feedback may be output, such as an alarm for cutting off the line and/or a cutting sound for cutting on the line. Upon completion of cutting out the entire closed path 60, i.e. when the heart is cut out, a further user-initiated effect may be the creation of a link, local in virtual space to the heart, to a website offering services to design and create a greeting card or other item based on the cut-out shape. Rather than produce a link in the three-dimensional virtual environment, the completion of cutting may simply direct the application to provide a link to the user of the mobile communications device 10, e.g. via the graphical user interface 54.

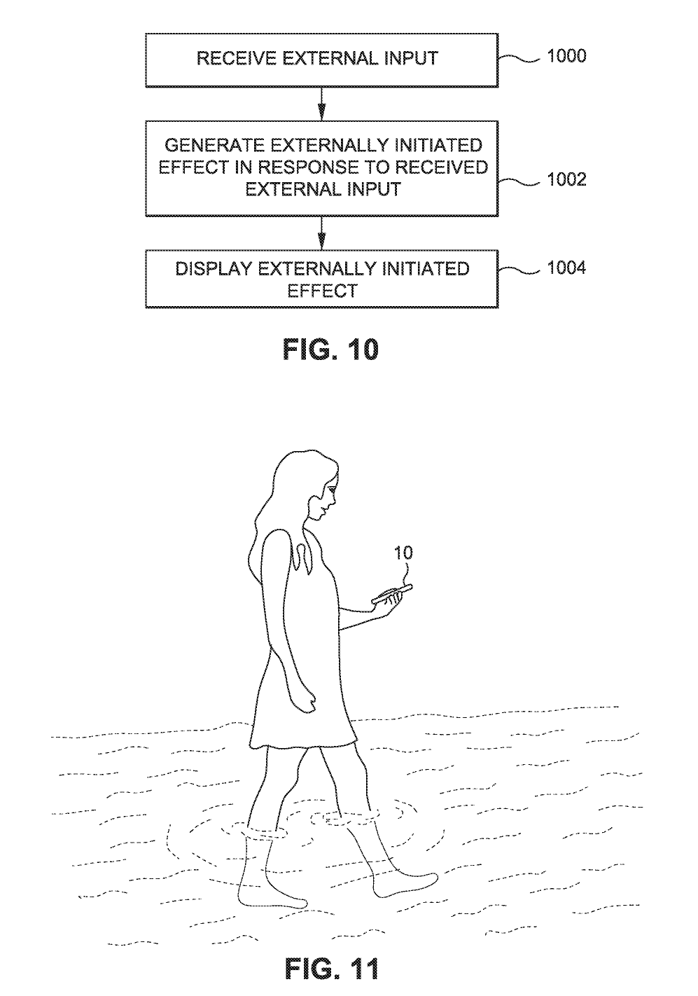

With reference to the flowchart of FIG. 10, an example sub-method of the method of FIG. 2 will be described. The sub-method of FIG. 10 may occur, for example, at any time before, during, or after the method of FIG. 2. The sub-method begins with a step 1000 of receiving an external input, e.g. on an external input modality of the mobile communications device 10. The external input modality of the mobile communications device 10 may include an indoor positioning system (beacon) receiver. Upon receiving a signal from an indoor positioning system transmitter by virtue of the mobile communications device 10 being brought in proximity thereto where such reception becomes possible, it is evaluated as such. In this case, the external input could be the receipt of the beacon signal. Alternatively, or additionally, the external input modality may include a wireless communications network receiver such as the RF transceiver 12 and/or may include the location module 40, in which case the external input may be the receipt of a wireless communications signal transmitted from a wireless communications network transmitter. For example, establishing a network link over particular wireless local area networks, being in a particular location as detected by the location module 40, being in a location with a particular type of weather reported, and so forth can be regarded as the receipt of the external input. Any subsequent signal received by such external input modalities after a connection or link is established, e.g. a signal initiated by a second user, by a business, or by the producer of the application, may also be regarded as the external input. The timing of the receipt of the external input is not intended to be limiting. Thus, the external input may also be pre-installed or periodically downloaded environment data or instructions, including data of virtual objects and other entities to be generated in a three-dimensional virtual environment.

The method for producing an immersive virtual experience continues with a step 1002 of generating, within the three-dimensional virtual environment, an externally initiated effect in response to the received external input. Like the user-initiated effect, the externally initiated effect may be any effect, e.g. the addition, removal, or change of any feature, within a three-dimensional virtual environment. Such effect may be visually perceptible, e.g. the creation of a new visual feature such as a drawn line or a virtual physical object. That is, the effect may be seen in a visual display of the three-dimensional virtual environment. Alternatively, or additionally, the user-initiated effect may be an auditory effect emanating from a specific locality in virtual space and perceivable on a loudspeaker (such as the loudspeaker 34 of the mobile communications device 10), a haptic effect emanating from a specific locality in virtual space and perceivable on a haptic output device (such as the touch screen 22 or a vibration module of the mobile communications device 10), a localized command or instruction that provides a link to a website or other remote resource to a mobile communications device 10 entering its proximity in virtual space, or any other entity that can be defined in a three-dimensional virtual environment and perceivable by an application that can access the three-dimensional virtual environment.

What is an externally initiated effect to a first user may be a user-initiated effect from the perspective of a second user. For example, in the case where two users are creating a collaborative drawing in a shared three-dimensional virtual environment, the first user may see the second user's portions of the collaborative drawing. In this case, the mobile communications device 10 of the second user may have generated a user-initiated effect at the second user's end and transmitted a signal representative of the effect to the first user's mobile communications device 10. Upon receiving the signal as external input, the first user's mobile communications device 10 may generate an externally initiated effect within the first user's three-dimensional virtual environment in response to the received external input, resulting in a shared three-dimensional virtual environment. In step 1006, the externally initiated effect may then be displayed on the mobile communications device 10 or an external device local or remote to the mobile communications device 10 in the same ways as a user-initiated effect, e.g. including displaying a movable-window view of the three-dimensional virtual environment on the mobile communications device 10. In this way, the second user's portion of the collaborative drawing may be visible to the first user in a shared three-dimensional virtual environment.

FIGS. 11-15 show examples of immersive virtual experiences produced according to the method of FIG. 2 and the sub-method of FIG. 10. In all of FIGS. 11-15, what the user may effectively see when looking through his/her mobile communications device 10 is shown for ease of understanding of the user's experience (even though the perspective of each drawing would generally prohibit it unless the drawing itself were an external large-area view or second movable-window view of the same three-dimensional virtual environment).

In FIG. 11, a user of a mobile communications device 10 is walking through virtual water. In the real world, the user may be walking in a room, through a field, or down the sidewalk while pointing her mobile communications device 10 to look at her feet. In accordance with step 1000 of FIG. 10, the mobile communications device 10 receives external input including data or instructions for generating the water environment. The external input may be preinstalled as part of the application or may be received on an external input modality of the mobile communications device 10, e.g. from a weather station as part of a flood warning. In response to the external input, the mobile communications device 10 generates (step 1002) and displays (step 1004) the water as an externally initiated effect within a three-dimensional virtual environment on the mobile communications device 10. At this point, the user in FIG. 11 can see the virtual water on her mobile communications device 10, for example, using a movable-window view. As the user walks, the mobile communications device 10 receives, in accordance with step 202 of FIG. 2, motion sensor input on a motion sensor input modality including, e.g., the accelerometer 46, the compass 50, and/or the gyroscope 48 (either integrated into the mobile communications device 10 or in a separate, external device wearable on the user's leg or foot and communicatively linked to the mobile communications device 10), which may be used in combination as a pedometer or other “soft” sensor, and the motion sensor input is translated to at least a set of quantified values per step 204. Additionally, in accordance with step 206, secondary input including still image or video capture data of the user's feet as the user points the mobile communications device 10 downward may be received on a secondary input modality including the camera 36 of the mobile communications device 10, and the secondary input may be translated to at least a set of secondary quantified values per step 208. In accordance with steps 210 and 212, such optional secondary input, in combination with pedometer or other motion sensor input may be used to approximate the user's leg positions and generate and display a user-initiated effect of the user's legs walking through the virtual water, e.g. virtual ripples moving outward from the user's legs and virtual waves lapping against the user's legs.

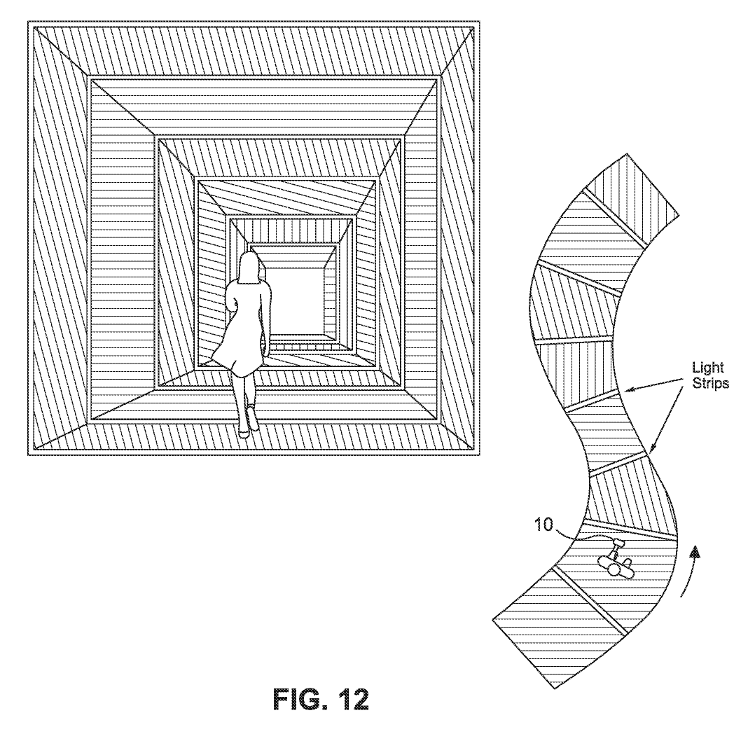

In FIG. 12, a user of a mobile communications device 10 is walking through a dark tunnel made up of segments separated by strips of light along floor, walls, and ceiling. In accordance with step 1000 of FIG. 10, the mobile communications device 10 receives external input including data or instructions for generating the tunnel environment. In response to the external input, the mobile communications device 10 generates (step 1002) and displays (step 1004) the tunnel as an externally initiated effect within a three-dimensional virtual environment on the mobile communications device 10. At this point, the user in FIG. 12 can see the virtual tunnel on her mobile communications device 10, for example, using a movable-window view. As the user walks, the mobile communications device 10 receives, in accordance with step 202 of FIG. 2, motion sensor input on a motion sensor input modality including, e.g., the accelerometer 46, the compass 50, and/or the gyroscope 48 (either integrated into the mobile communications device 10 or in a separate, external device wearable on the user's leg or foot and communicatively linked to the mobile communications device 10), which may be used in combination as a pedometer or other “soft” sensor, and the motion sensor input is translated to at least a set of quantified values per step 204. Additionally, in accordance with step 206, secondary input including still image or video capture data of the user's feet as the user points the mobile communications device 10 downward may be received on a secondary input modality including the camera 36 of the mobile communications device 10, and the secondary input may be translated to at least a set of secondary quantified values per step 208. In accordance with steps 210 and 212, such optional secondary input, in combination with pedometer or other motion sensor input may be used to approximate the user's leg positions and generate and display a user-initiated effect of each tunnel segment or strip of light illuminating as the user's feet walk onto that tunnel segment or strip of light.

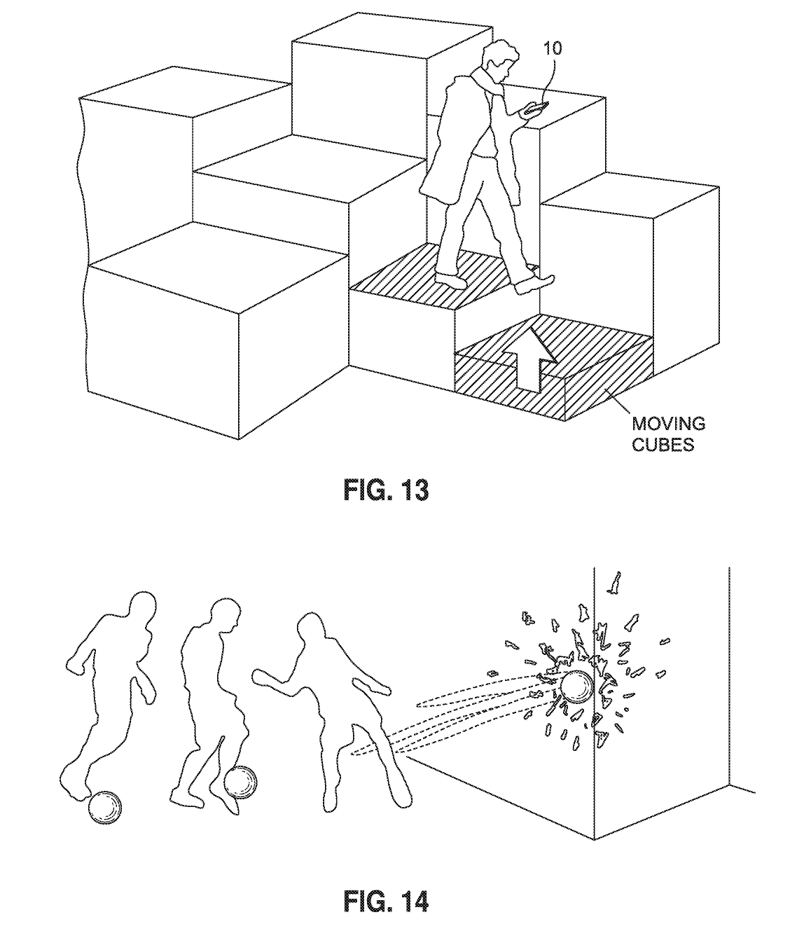

In FIG. 13, a user of a mobile communications device 10 is walking on a floor filled with rectangular blocks. In accordance with step 1000 of FIG. 10, the mobile communications device 10 receives external input including data or instructions for generating the block environment. In response to the external input, the mobile communications device 10 generates (step 1002) and displays (step 1004) the blocks as an externally initiated effect within a three-dimensional virtual environment on the mobile communications device 10. At this point, the user in FIG. 13 can see the blocks on her mobile communications device 10, for example, using a movable-window view, and it appears to the user that he is walking on top of the blocks. As the user walks, the mobile communications device 10 receives, in accordance with step 202 of FIG. 2, motion sensor input on a motion sensor input modality including, e.g., the accelerometer 46, the compass 50, and/or the gyroscope 48 (either integrated into the mobile communications device 10 or in a separate, external device wearable on the user's leg or foot and communicatively linked to the mobile communications device 10), which may be used in combination as a pedometer or other “soft” sensor, and the motion sensor input is translated to at least a set of quantified values per step 204. Additionally, in accordance with step 206, secondary input including still image or video capture data of the user's feet as the user points the mobile communications device 10 downward may be received on a secondary input modality including the camera 36 of the mobile communications device 10, and the secondary input may be translated to at least a set of secondary quantified values per step 208. In accordance with steps 210 and 212, such optional secondary input, in combination with pedometer or other motion sensor input may be used to approximate the user's leg positions and generate and display a user-initiated effect of each block rising or falling as the user steps on it, e.g. by magnifying or zooming in and out of the ground surrounding the block in the user's view.

In FIG. 14, a user of a mobile communications device 10 is kicking a virtual soccer ball. In accordance with step 1000 of FIG. 10, the mobile communications device 10 receives external input including data or instructions for generating the soccer ball virtual object. In response to the external input, the mobile communications device 10 generates (step 1002) and displays (step 1004) the soccer ball as an externally initiated effect within a three-dimensional virtual environment on the mobile communications device 10. At this point, the user in FIG. 14 can see the soccer ball on his mobile communications device 10, for example, using a movable-window view. As the user moves his foot to kick the soccer ball, the mobile communications device 10 receives, in accordance with step 202 of FIG. 2, motion sensor input on a motion sensor input modality including, e.g., an accelerometer 46, the compass 50, and/or the gyroscope 48 in a separate, external device wearable on the user's leg or foot and communicatively linked to the mobile communications device 10, and the motion sensor input is translated to at least a set of quantified values per step 204. Additionally, in accordance with step 206, secondary input including still image or video capture data of the user's feet as the user points the mobile communications device 10 downward may be received on a secondary input modality including the camera 36 of the mobile communications device 10, and the secondary input may be translated to at least a set of secondary quantified values per step 208. In accordance with steps 210 and 212, such optional secondary input in combination with motion sensor input may be used to approximate the user's foot position and generate and display a user-initiated effect of kicking the soccer ball. As the user's foot strikes the virtual ball, haptic feedback in the form of a jolt or impact sensation may be output to the external device on the user's foot in accordance with step 214. The user may then view the kicked virtual soccer ball as it flies through the air using a movable-window view on his mobile communications device 10. Using the camera 36 to receive further secondary input, the mobile communication device 10 may further approximate the moment that the virtual ball strikes a real-world wall and may generate additional effects in the three-dimensional virtual environment accordingly, e.g. a bounce of the ball off a wall or a shatter or explosion of the ball on impact with a wall.

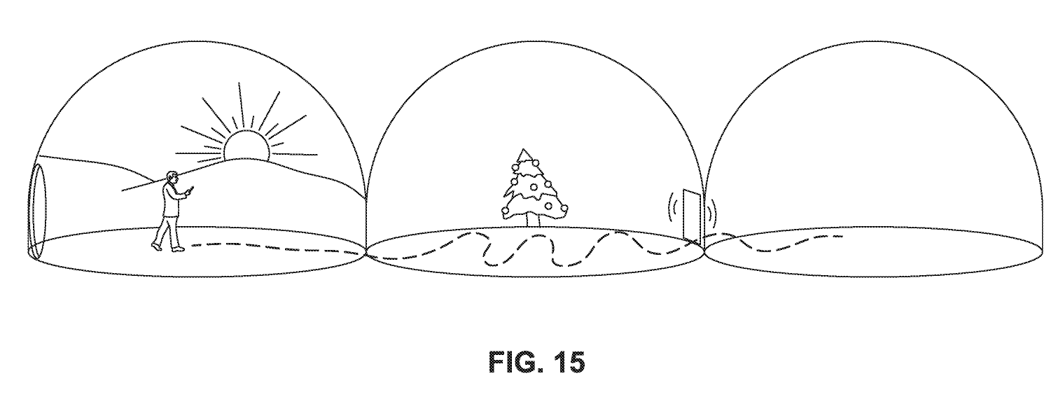

In FIG. 15, a user of a mobile communications device 10 is walking through a series of virtual domes and having various interactive experiences in accordance with the methods of FIGS. 2 and 10 and the various techniques described above. First, the user moves from the right-most dome to the middle dome by opening a virtual door using a motion trigger, e.g. a shake of the mobile communication device 10 in the vicinity of a virtual doorknob. The opening of the door may be a user-initiated effect generated in response to a substantial match between quantified values translated from received motion sensor input of the shaking of the mobile communication device 10 to predefined values. In the middle dome, the user decorates a virtual Christmas tree using virtual ornaments and other virtual decorations. Virtual objects can be lifted and placed, e.g. by the hand of the user that is holding the mobile communication device 10. Virtual objects can be picked up and released by any motion sensor input or secondary input, e.g. a shake of the mobile communication device 10. When the user is satisfied with the decoration of the Christmas tree, he may follow a link to send a Christmas card including the Christmas tree to another person or invite another user to view the completed Christmas tree in a three-dimensional virtual environment. Lastly, in the left-most room, the user may enjoy a virtual sunset view in 360-degree panoramic. The user is looking at the real world through his mobile communications device 10 in a movable-window view, with the virtual sunset displayed as an external effect based on external input in the form of sunset data or instructions. As the virtual sun sets, the real world as viewed through the movable-window view undergoes appropriate lighting effects based on the viewing position (received as motion sensor input to generate a user-initiated effect) and the state of the virtual sunset (received as external input to generate an externally initiated effect).

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for producing an immersive virtual experience using a mobile communications device, the method comprising:
receiving a motion sensor input on a motion sensor input modality of the mobile communications device;
translating the motion sensor input to at least a set of quantified values; and
generating, within a three-dimensional virtual environment, a user-initiated effect in response to a substantial match between the set of quantified values translated from the received motion sensor input to a set of predefined values.

2. The method of claim 1, further comprising:
displaying the user-initiated effect on the mobile communications device.

3. The method of claim 2, wherein said displaying the user-initiated effect includes displaying a movable-window view of the three-dimensional virtual environment on the mobile communications device.

4. The method of claim 1, further comprising:
outputting, on the mobile communications device, at least one of visual, auditory, and haptic feedback in response to a substantial match between the set of quantified values translated from the received motion sensor input to a set of predefined values.

5. The method of claim 1, further comprising:
displaying, on the mobile communications device, user-initiated effect invocation instructions corresponding to the set of predefined values.

6. The method of claim 1, further comprising:
receiving an external input on an external input modality of the mobile communications device; and
generating, within the three-dimensional virtual environment, an externally initiated effect in response to the received external input.

7. The method of claim 6, further comprising:
displaying the externally initiated effect on the mobile communications device.

8. The method of claim 7, wherein said displaying the externally initiated effect includes displaying a movable-window view of the three-dimensional virtual environment on the mobile communications device.

9. The method of claim 6, wherein:
the external input modality includes an indoor positioning system receiver; and
the external input is a receipt of a beacon signal transmitted from an indoor positioning system transmitter.

10. The method of claim 6, wherein:
the external input modality includes a wireless communications network receiver; and
the external input is a receipt of a wireless communications signal transmitted from a wireless communications network transmitter.

11. The method of claim 1, wherein the motion sensor input modality includes at least one of an accelerometer, a compass, and a gyroscope.

12. The method of claim 11, wherein:
the at least one of an accelerometer, a compass, and a gyroscope is integrated into the mobile communications device; and
the motion sensor input is a sequence of motions applied to the mobile communications device by a user that are translated to the set of quantified values by the at least one of an accelerometer, a compass, and a gyroscope.

13. The method of claim 11, wherein:
the at least one of an accelerometer, a compass, and a gyroscope is in an external device wearable by a user and in communication with the mobile communications device; and
the motion sensor input is a sequence of motions applied to the external device by the user that are translated to the set of quantified values by the at least one of an accelerometer, a compass, and a gyroscope.

14. The method of claim 11, wherein the motion sensor input is movement of the mobile communications device or steps walked or run by a user as measured by an accelerometer.

15. The method of claim 11, wherein the motion sensor input is a physical gesture as measured by a gyroscope.

16. The method of claim 11, wherein the motion sensor input is a direction as measured by a compass.

17. The method of claim 11, wherein the motion sensor input is steps walked or run by a user in a defined direction as measured by a combination of an accelerometer and a compass.

18. The method of claim 1, further comprising:
receiving a visual, auditory, or touch input on a secondary input modality of the mobile communications device; and
translating the visual, auditory, or touch input to at least a set of secondary quantified values;
wherein said generating the user-initiated effect is further in response to a substantial match between the set of secondary quantified values translated from the visual, auditory, or touch input to the set of predefined values.

19. The method of claim 18, wherein:
the secondary input modality includes a camera; and
the visual, auditory, or touch input includes a sequence of user gestures graphically captured by the camera.

20. An article of manufacture comprising a non-transitory program storage medium readable by a mobile communications device, the medium tangibly embodying one or more programs of instructions executable by the device to perform a method for producing an immersive virtual experience, the method comprising:
receiving a motion sensor input on a motion sensor input modality of the mobile communications device;
translating the motion sensor input to at least a set of quantified values; and
generating, within a three-dimensional virtual environment, a user-initiated effect in response to a substantial match between the set of quantified values translated from the received motion sensor input to a set of predefined values.

21. The article of manufacture of claim 20, further comprising:
the mobile communications device;
wherein the mobile communications device includes a processor or programmable circuitry for executing the one or more programs of instructions.

22. A mobile communications device operable to produce an immersive virtual experience, the mobile communications device comprising:
a motion sensor for receiving a motion sensor input and translating the motion sensor input to at least a set of quantified values; and
a processor for generating, within a three-dimensional virtual environment, a user-initiated effect in response to a substantial match between the set of quantified values translated by the motion sensor from the received motion sensor input to a set of predefined values.
